(19) United States
(12) Patent Application Publication
(10) Pub. No.: US 2007/0155620 A1
(43) Pub. Date: Jul. 5, 2007

(54) Bimodal polyethylene

(76) Inventors: Olivier Lavastre, Gahard (FR); Laurent Gallard, Villiers sur Chize (FR); Abbas Razavi, Mons (BE)

Correspondence Address: FINA TECHNOLOGY INC, PO BOX 674412, HOUSTON, TX, 77267-4412, US

(21) Appl. No.: 10/573,507

(22) PCT Filed: Sep. 23, 2004
(86) PCT No.: PCT/EP04/52291

§ 371 Date: Aug. 28, 2006

(30) Foreign Application Priority Data
Sep. 29, 2003 (FR) 03/11391

(51) Int. Cl. C08G 85/00; B01J 27/24

(52) U.S. Cl. 502/200; 526/65; 526/161; 526/113; 526/114; 526/904; 502/113

(57) ABSTRACT

The present invention discloses a method for preparing a catalyst component suitable for the preparation of bimodal polymers that comprises the steps of a) providing hollow beads of polyethylene of controlled morphology and size; b) drying the hollow beads under vacuum; c) impregnating the dried hollow beads with a concentrated solution of the desired catalyst component under vacuum; d) submitting the impregnated hollow beads to atmospheric pressure; e) draining excess liquid; f) drying under inert gas at atmospheric pressure. It also discloses a method for preparing bimodal polymers that uses the new catalyst component catalyst.

This invention relates to the field of polyolefins having a bimodal molecular weight distribution.

In many applications in which polyolefins are employed, it is desirable that the polyolefin used has good mechanical properties. It is known that, in general, high molecular weight polyolefins have good mechanical properties. Additionally, since the polyolefin must usually undergo some form of processing (such as moulding processes and extrusion processes and the like) to form the final product, it is also desirable that the polyolefin used has good processing properties. However, unlike the mechanical properties of the polyolefin, its processing properties tend to improve as its molecular weight decreases.

Thus, a problem exists to provide a polyolefin that simultaneously exhibits favourable mechanical properties and favourable processing properties. Attempts have been made in the past to solve this problem, by producing polyolefins having both a high molecular weight component (HMW) and a low molecular weight component (LMW). Such polyolefins have either a broad molecular weight distribution (MWD), or a multimodal molecular weight distribution.

There are several methods for the production of multimodal or broad molecular weight distribution polyolefins. The individual polyolefins can be melt blended, or can be formed in separate reactors in series. Use of a dual site catalyst for the production of a bimodal polyolefin resin in a single reactor is also known.

Chromium catalysts for use in polyolefin production tend to broaden the molecular weight distribution and can in some cases produce bimodal molecular weight distribution, but usually the low molecular part of these resins contains a substantial amount of the co-monomer. Whilst a broadened molecular weight distribution provides acceptable processing properties, a bimodal molecular weight distribution can provide excellent properties.

Ziegler-Natta catalysts are known to be capable of producing bimodal polyethylene using two reactors in series. Typically, in a first reactor, a low molecular weight homopolymer is formed by reaction between hydrogen and ethylene in the presence of the Ziegler-Natta catalyst. It is essential that excess hydrogen be used in this process and, as a result, it is necessary to remove all the hydrogen from the first reactor before the products are passed to the second reactor. In the second reactor, a copolymer of ethylene and hexene is made so as to produce a high molecular weight polyethylene.

Metallocene catalysts are also known in the production of polyolefins. For example, EP-A-0619325 describes a process for preparing polyolefins having a bimodal molecular weight distribution. In this process, a catalyst system which includes two metallocenes is employed. The metallocenes used are, for example, a bis(cyclopentadienyl)zirconium dichloride and an ethylene-bis(indenyl)zirconium dichloride. By using the two different metallocene catalysts in the same reactor, a molecular weight distribution is obtained, which is at least bimodal.

A problem with known bimodal polyolefins is that if the individual polyolefin components are too different in molecular weight and density, they may not be as miscible with each other as desired and harsh extrusion conditions or repeated extrusions are necessary which might lead to partial degradation of the final product and/or additional cost. Thus the optimum mechanical and processing properties are not achieved in the final polyolefin product. Thus, many applications still require improved polyolefins and there is still a need to control the molecular weight distribution of the polyolefin products more closely, so that the miscibility of the polyolefin components can be improved, and in turn the mechanical and processing properties of the polyolefins can be further improved.

It is an aim of the present invention to provide a new method for preparing an active catalyst system for the polymerisation of bimodal polymers.

It is also an aim of the present invention to provide a new method for polymerising bimodal polymers.

it is a further aim of the present invention to provide new bimodal polymers with improved properties.

Accordingly, the present invention discloses a method for preparing a catalyst component suitable for the polymerisation of bimodal polymers that comprises the steps of:
a) providing hollow beads of polyethylene of controlled morphology and size;
b) drying the hollow beads under vacuum;
c) impregnating the dried hollow beads with a concentrated solution of the desired catalyst component under vacuum;
d) returning the impregnated hollow beads slowly to atmospheric pressure;
e) draining excess liquid;
f) drying under inert gas at atmospheric pressure
The hollow beads of polyethylene are prepared by the steps of:
i) providing a supported catalyst component wherein the support is a porous functionalised bead of polystyrene and wherein the catalyst component is covalently bound to the support and is an iron based complex of general formula (I) 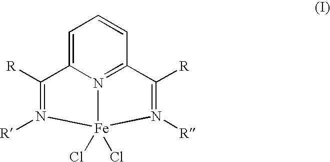
   wherein R are the same and are an alkyl having from 1 to 20 carbon atoms and wherein R′ and R″ are the same or different and are a substituted or unsubstituted alkyl having from 1 to 20 carbon atoms, or a unsubstituted or substituted aryl having substituents from 1 to 20 carbon atoms;
ii) activating the supported catalyst with a suitable activating agent;
iii) feeding the ethylene monomer;
iv) maintaining under polymerization conditions;
v) retrieving hollow beads of polyethylene of controlled morphology and size.
The R groups are the same and are preferably an alkyl having from 1 to 4 carbon atoms, more preferably, they are methyl.

R′ and R″ are the same or different and are selected from a substituted or unsubstituted alkyl having from 1 to 6 carbon atoms or are a unsubstituted or substituted aryl having substituents from 1 to 6 carbon atoms. Preferably, R′ and R″ are the same and are substituted or unsubstituted phenyls. The substitutents on the phenyls, if present, can have either an inductive attracting, donating effect or a steric effect.

The substituents that have an inductive attracting or donating effect can be selected from hydrogen or an alkoxy, or NO₂, or CN, or CO2R or an alkyl having from 1 to 20 carbon atoms, or a halogen or CX3 wherein X is a halogen, preferably fluor, or a fused ring between positions 3 and 4, or between positions 4 and 5 or between positions 5 and 6.

The steric environment of the iron-based complex is determined by the substituents at positions 2 and 6 and optionally at positions 3, 4 and 5 on the phenyls.

For the steric effect, the preferred substituents on the phenyls, if present, can be selected from tert-butyl, isopropyl or methyl. The most preferred substituents are isopropyl in positions 2 and 6 or methyl in positions 2, 4 and 6.

The hollow beads are dried under vacuum at a temperature of from −20 to 50° C., preferably at room temperature (about 25° C.) in order to remove all traces of solvent.

A 0.1.10⁻³ to 1 molar solution of the desired catalyst component is then added to the dry hollow beads, under vacuum and at room temperature (about 25° C.). The solvent is selected typically from CH₂Cl₂, THF, or CH₃CN.

The impregnated hollow beads are then brought back slowly to atmospheric pressure in order to further in crease the amount of catalyst component absorbed.

In this embodiment, the beads are fully impregnated with the desired catalyst component.

In another embodiment according to the present invention, the impregnation of the hollow beads may be restricted to their surface. The method of preparation described here-above is modified in that:
the impregnating time is decreased typically from an impregnation time of about 2 hours to an impregnation time of about 30 minutes;
the impregnation is carried out at atmospheric pressure.

Alternatively, in a further embodiment according to the present invention, the surface impregnation is removed in order prepare a catalyst component located essentially inside the hollow bead. The method of preparation described here-above is modified in that:
after step e) the impregnated and dried beads are washed rapidly in order to remove the surface catalytic component;
they are then rapidly drained and dried.

Rapid in this context is meant to remove solely the superficial component of the catalyst and covers a period of time of from 20 seconds to 2 minutes, preferably from 30 to 60 seconds.

A catalyst system is then prepared by activating the supported catalyst component with a suitable activating agent.

The activating agent can be selected from aluminoxane or aluminium alkyl.

The aluminium alkyls that can be used are of the formula AlRₓ, wherein each R is the same or different and is selected from halides or from alkoxy or alkyl groups having from 1 to 12 carbon atoms and x is from 1 to 3. Especially suitable aluminiumalkyl are dialkylaluminum chloride, the most preferred being diethylaluminum chloride (Et₂AlCl).

Aluminoxane is used to activate the catalyst component during the polymerisation procedure, and any aluminoxane known in the art is suitable.

The preferred aluminoxanes comprise oligomeric linear and/or cyclic alkyl aluminoxanes represented by the formula: 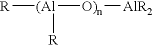
for oligomeric, linear aluminoxanes and 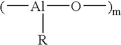
for oligomeric, cyclic aluminoxanes, wherein n is 1-40, preferably 10-20, m is 3-40, preferably 3-20 and R is a C₁-C₈ alkyl group and preferably methyl.

Methylaluminoxane (MAO) is preferably used.

Boron-based activating agents can also be used. They comprise triphenylcarbenium boronates such as tetrakis-pentafluorophenyl-borato-triphenylcarbenium [C(Ph)₃⁺B(C₆F₅)₄] as described in EP-A-0,427,696.

Other boron-based activating agents are disclosed in EP-A-0,277,004.

The catalyst component is contacted with the activating agent for a period of time of less than 5 minutes, preferably of from 30 seconds to 2 minutes. The active catalyst component is drained and injected into the second reaction zone with the same or another monomer. The same or other monomer is an alpha-olefin of from 1 to 8 carbon atoms.

In this invention the hollow beads of polyethylene prepared in the first reaction zone have a high molecular weight and a high density. The conditions in the second reaction zonz are adjusted to prepare a polymer component that has a low molecular weight and a low density. The resulting final polymer is bimodal.

Preferably the reactor used in the present invention is a double loop reactor.

### LIST OF FIGURES

FIG. 1 represents porous polyethylene beads after impregnation with a catalyst component.

FIG. 2 represents particles of polyethylene resulting from the second polymerisation.

FIG. 3 represents the double polymerisation scheme that was used to obtain the particles of FIG. 2.

FIG. 4 represents the molecular weight distributions of the polymers respectively after one polymerisation (beads) and after two polymerisations (blocks).

### EXAMPLES

The starting materials and reagents, purchased from commercial suppliers, were used after standard purifications. The solvents were dried and distilled before use as follows:
over sodium and benzophenone for toluene and tetrahydrofuran (THF),
over sodium for methanol and
over phosphorus pentoxide for dichloromethane (DCM).

Experiments without beads were all performed on a vacuum line under argon, either using standard Schlenk tube techniques or a Jacomex glove box.

NMR spectra were recorded on a Bruker DPX 200 at 200 MHz for ¹H and at 50 MHz for ¹³C.

Infrared ATR spectra were recorded in the range of from 4000 to 400 cm⁻¹ on silicium on a IR Centaurμs microscope.

High resolution mass spectra were obtained on a Varian MAT 311 (electronic ionisation mode) at CRMPO, University of Rennes.

Elemental analysis were performed by the CNRS laboratory at Vernaison (France).

Synthesis of the Catalyst.

The synthesis of bisimines from 2,6-diacethylpyridine was performed as described for example in Britovsek et al. (G. J. P. Britovsek, M. Bruce, V. C. Gibson, B. S. Kimberley, P. J. Maddox, S. Mastroianni, S. J. McTavish, C. Redshaw, G. A. Solan, S. Strömberg, A. J. P. White, D. J. Williams, in J. Am. Chem. Soc., 1999, 8728.). To form the iron complex, the procedure described in Small and Brookhart (L. Small and M. Brookhart, in Macromolecules, 1999, 2120.) was applied: iron (II) chloride was added to the bisimines in tetrahydrofuran (THF). The reaction was allowed to stir at reflux for 30 minutes. The reaction mixture was cooled at room temperature. The precipitate of iron complex appeared and the mixture was filtrated. The precipitate was dried under vacuum.

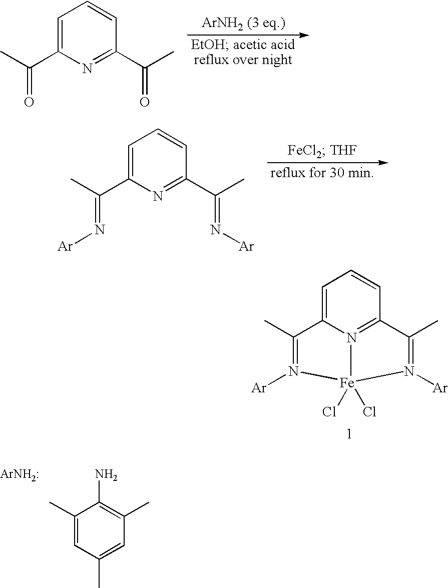

To a refluxed homogenous solution of 163 mg (1 mmol) of 2,6-diacetylpyridine in 3 mL of absolute ethanol under argon atmosphere, 406 mg (3 mmol) of 2,4,6-trimethylaniline were added. After the addition of a few drops of glacial acetic acid, the solution was refluxed for 20 hours at a temperature of 90° C. Upon cooling to room temperature, the product crystallized from ethanol. After filtration the yellow solid was washed with cold ethanol and dried under reduced pressure (which pressure??) to give 0.164 g (42%) of the bisimine.

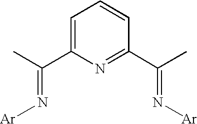

45.77 mg (0.23 mmol) of iron (II) chloride tetrahydrate were dried under reduced pressure (which pressure??) at a temperature of 120° C. for a period of time of 5 hours. The iron (II) chloride was added to the bisimines in THF. The reaction was allowed to stir at reflux for 30 minutes. The reaction mixture was cooled at room temperature. The precipitate of iron complex appeared and the mixture was filtrated and dried under a reduced pressure of 2 mm Hg to give 0.104 g (87%) of the blue complex 1. 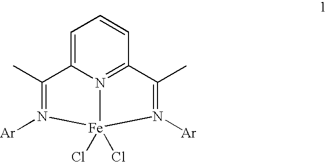
Impregnation of Polystyrene Porous Beads.

Under argon, to 177 mg (0.2 mmol) of polystyrene AM —NH₂ beads purchased from Rapp polymere (1,13 mmol/g, 250-315 μm) in 3.6 mL of dichloromethane (DCM), 0.44 mL (0.3 mmol) of triethylamine were slowly added. This addition was followed by a careful addition of 0.36 mL (2.4 mmol) of 6-bromohexanoyl chloride. The reaction mixture was stirred for 2 hours at room temperature on a rotato before being drained. The beads were then washed twice for 30 minutes with dimethylformamide, twice for 10 minutes with DCM, twice for 10 minutes with methanol, twice for 30 minutes with dimethylformamide, twice for 10 minutes with DCM, twice for 30 minutes with methanol and then dried under reduced pressure to give 0.2 mmol of the white beads 2. A Kaiser test was performed to verify that the reaction was complete.

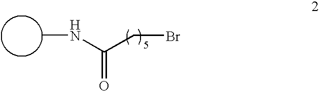

In a glove box, a 8.9×10⁻³ molar solution of iron complex (1) in DCM was prepared by dissolving 23.3 mg (0.0448 mmol) of complex (1) in 5 mL of DCM. This solution was added to the beads (2). The mixture was stirred at room temperature for 2 hours on a rotating shaker. They were then drained, washed quickly with 2 mL of DCM and then dried under reduced pressure. The same operation was exactly repeated a second time. The mixture was stirred at room temperature for 2 hours on a rotato. The beads were drained, washed quickly with 2 mL of DCM and then dried under reduced pressure to give the blue beads (3). The amount of iron was measured as:

Fe_{(ICP AES)}: 630 ppm (wt).

Total loading of beads (3): 1.128×10⁻² mmol Fe/g of beads.

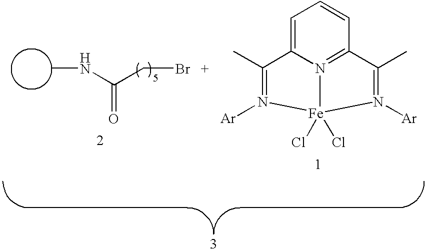

### Example 1

Polymerisation of Ethylene in First Reaction Zone.

Under argon, 55 mL of toluene, folio wed by 3.2 mL of MAO (30% wt in toluene) were added in a 200 mL stainless steel reactor. The reactor was flushed with argon for 5 minutes. 2 mL of toluene were added to the reactor and 2 minutes later, 8.4 mg of the dried beads (3)(9.47×10⁻⁸ mol Fe) were quickly injected into the reactor. The reactor was again flushed with argon for 5 minutes. The temperature was raised to 50° C., the reactor was put under 20 bar of ethylene and the reaction mixture was stirred for 3 hours. The reaction mixture was brought back to room temperature under argon, and afterwards, the solution was removed, the beads were washed with methanol and dried under reduced pressure to give 0.727 g of porous spherical polyethylene particles having a size of from 0.5 to 1.5 mm. The activity was measured as 7.67 Tons of polyethylene produced per mole of iron.

Impregnation of the Porous Beads of Polyethylene with a Second Catalyst Component.

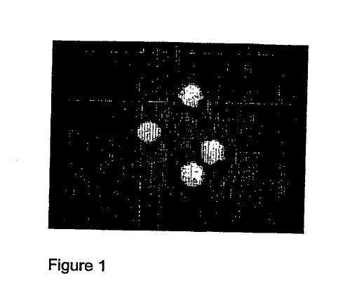

In a glove box, 150 mg of polyethylene beads were washed with 5 mL of toluene for a day on a rotating shaker. A 5.7×10⁻³ molar solution of iron complex 1 in DCM was prepared by dissolving 6 mg (1.14×10⁻⁵ mol) of complex 1 in 2 mL of DCM. This solution was added on the beads in a Schlenk tube under a reduced pressure. The beads stayed with the solution under reduced pressure for a period of time of 30 minutes. After returning to atmospheric pressure, the beads were drained and washed quickly with 1 mL of toluene then dried under reduced pressure to give grey beads of polyethylene represented in FIG. 1.

Polymerisation of Ethylene in Second Reaction Zone.

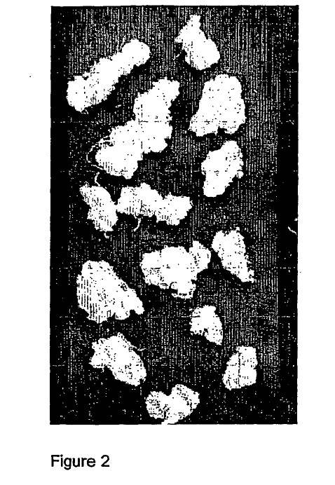

Under argon, 55 mL of toluene were added to a 200 mL stainless steel reactor followed by the addition of 4 mL of MAO (30% in toluene). The reactor was flushed with argon for 5 minutes. 48 mg of the dried impregnated beads were quickly injected without toluene in the reactor. The reactor was flushed again under argon for 2 minutes. The temperature was raised to 50° C., the reactor was put under a pressure of 20 bars of ethylene and the reaction mixture was stirred for 3 hours. The reaction mixture was then brought back to room temperature under argon, the solution was removed and the blocks of polyethylene were washed with methanol and dried under reduced pressure to give 0.838 g of polyethylene particles represented in FIG. 2.

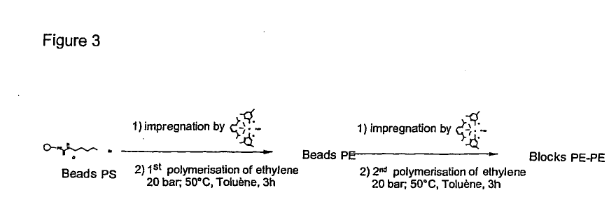

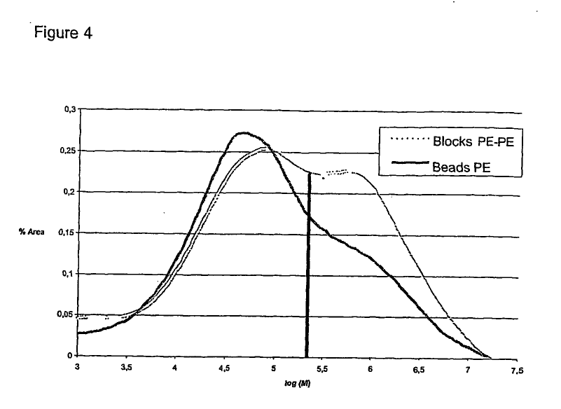

The sequence of steps used to prepare the particles of final polymer are summarised in FIG. 3 and the molecular weight distributions of the beads of polyethylene obtained after the first polymerisation and of the particles of polyethylene obtained after both polymerisations are represented in FIG. 4.

The polydispersity of the polymer obtained after two polymerisations clearly has a bimodal character.

1-16. (canceled)

17. A method for the preparation of a supported olefin polymerization catalyst comprising:
a) providing an accumulation of hollow polyethylene beads;
b) placing said polyethylene beads under a vacuum to dry said beads;
c) contacting said dried polyethylene beads with a solution of a olefin polymerization catalyst component to impregnate said beads with said catalyst component;
d) draining excess liquid from said accumulation of polyethylene beads; and
e) drying said accumulation of polyethylene beads under an inert gas atmosphere.

18. The method of claim 17 wherein said dried hollow beads are contacted with said catalyst solution for a period within the range of one half to about two hours.

19. The method of claim 17 wherein the impregnation of said beads with said solution of olefin polymerization catalyst component is carried out under a vacuum followed by increasing the pressure on said accumulation of polyethylene beads prior to draining said excess liquid in subparagraph d).

20. The method of claim 17 wherein said dry polyethylene beads are contacted with said solution of olefin polymerization catalyst at atmospheric pressure to provide a supported catalyst system in which said supported catalyst component is located predominantly on the surface of said hollow beads.

21. The method of claim 20 wherein said hollow beads are contacted with said catalyst solution for a period of about one-half hour.

22. The method of claim 17 wherein subsequent to the draining of said excess liquid from said hollow beads, said hollow beads are washed with a solvent for a period of time effective to remove said catalyst component from the surfaces of said beads to provide a supported catalyst system in which the supported catalyst component is predominantly located within the interior of said hollow beads.

23. The method of claim 22 wherein said hollow beads are washed with said solvent for a period of time within the range of 20 seconds to 2 minutes.

24. The method of claim 22 wherein said hollow beads are washed with said solvent for a period of time within the range of 30 to 60 seconds.

25. The method of claim 17 wherein the said hollow polyethylene beads of subparagraph a) are prepared by
i) providing a supported catalyst component wherein the support comprises porous to functionalize beads of polystyrene and the catalyst component is covalently bound to the support and is an ion based complex characterized by the general formula (I) 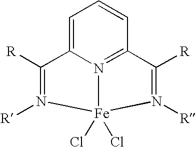
wherein R is an alkyl group having from 1-20 carbon atoms and R′ and R″ are the same or different and are an alkyl group having from 1-20 carbon atoms or/an unsubstituted aryl group or a substituted aryl having at least one substituent having from 1-20 carbon atoms;
ii. activating the supported catalyst component with an activating agent;
iii. supplying ethylene to a reaction zone containing said supported catalyst component and maintaining said reaction zone under polymerization conditions; and
iv. retrieving hollow polyethylene beads from said reaction zone to provide said accumulation of hollow polyethylene beads.

26. The method of claim 25 wherein R is a C₁-C₄ alkyl group.

27. The method of claim 26 wherein R is a methyl group.

28. The method of claim 27 wherein R′ and R″ are the same and are a substituted or unsubstituted phenyl group.

29. The method of claim 28 wherein R′ and R″ are substituted phenyl groups with substituents at the 2 and 6 position.

30. The method of claim 29 wherein said substituents are selected from the group consisting of methyl, isopropyl, and tertiary butyl group.

31. The method of claim 29 wherein substituents are isopropyl groups.

32. The method of claim 31 wherein said phenyl groups are substituted at the 2, 4 and 6 positions.

33. A supported catalyst system comprising:
a) a supported catalyst component produced by the process;
i) providing an accumulation of hollow polyethylene beads;
ii) placing said polyethylene beads under a vacuum to dry said beads;
iii) contacting said dried polyethylene beads with a solution of an olefin polymerization catalyst component to impregnate said beads with said catalyst component;
iv) draining excess liquid from said accumulation of polyethylene beads;
v) drying said accumulation of polyethylene beads under an inert gas atmosphere;
vi) recovering said polyethylene beads containing said catalyst component supported thereon;
b) an activating agent in contact with said supported catalyst component.

34. The supported catalyst system of claim 33 wherein said activating agent is methylalumoxane.

35. A method for the preparation of a bimodal polymer comprising:
a) preparing hollow polyethylene beads in a first reaction zone;
b) recovering an accumulation of said hollow polyethylene beads from said first reaction zone;
c) preparing a supported olefin polymerization catalyst system comprising an olefin polymerization catalyst supported on an accumulation of said hollow polyethylene beads and an activating agent for said supported catalyst component;
d) supplying the catalyst system of subparagraph c) to a second reaction zone;
e) supplying an alpha olefin monomer to said second reaction zone;
f) maintaining said second reaction zone under conditions effective for the polymerization of said alpha olefin monomer; and
g) recovering a bimodal polymer of said alpha olefin monomer from said second reaction zone.

36. The method of claim 35 wherein the alpha olefin monomer supplied to said second reaction zone is a C₂-C₄ alpha olefin.

37. The method of claim 36 wherein said first and second reaction zones comprise loop type reactors.
